(19) United States
(12) Patent Application Publication
(10) Pub. No.: US 2014/0298192 A1
(43) Pub. Date: Oct. 2, 2014

(54) DISPLAY SYSTEM AND METHOD

(71) Applicant: GENERAL ELECTRIC COMPANY, Schenectady, NY (US)

(72) Inventors: Uday Biradar, Mumbai (IN); Sahil Gandhi, Khopoli (IN)

(73) Assignee: General Electric Company, Schenectady, NY (US)

(21) Appl. No.: 13/851,179

(22) Filed: Mar. 27, 2013

(51) Int. Cl. G06F 3/0484

(52) U.S. Cl. CPC G06F 3/0484
USPC 715/744

(57) ABSTRACT

A display system integrates a desktop application user interface into a web-based application. A first computing device includes a first processor and a first display device. A first server supports a web-based application having a first user interface. The first display device presents to a user a first user interface that displays a first item of information. A second server, physically separated from the first server, is coupled to the first server via a web-based connection. A second computing device supports a desktop application that includes a second user interface. After a user has opened the web-based application, the first processor connects to the desktop application via the web-based application. The first processor displays, within a portion of the first user interface, at least a portion of the second user interface, presenting to the user a second item of information that is contextually connected to the first item of information.

### BACKGROUND OF THE INVENTION

The embodiments described herein relate generally to display systems for monitoring, measurement and control systems and, more particularly, to display systems and methods for providing integration of desktop applications into web-based applications.

Monitoring, measurement and control systems, for example, for use in control rooms for factories and processing plants (for example, refineries), often use web-based applications for supporting display systems that present information relating to ongoing processes or operations of equipment, including individual machines as well as overall systems. Such display systems are used by control personnel to monitor and control overall processes as well as individual machines or systems. However, such display systems typically provide high-level process or operations information in summary form and do not provide users with the ability to access more detailed (“rich”) content, in the manner that desktop applications for monitoring, measurement and control systems are capable of doing. Frequently, personnel such as repair and maintenance technicians, require more detailed information than web-based display systems can provide.

Accordingly, it would be desirable to provide a web-based display system for use in monitoring, measurement and control systems, with the ability to provide rich content that desktop applications can provide.

### BRIEF DESCRIPTION OF THE INVENTION

In one aspect, a display system for use in integrating a desktop application user interface into a web-based application is provided. The display system includes a first computing device including a first processor coupled to a first display device. The display system also includes a first server coupled to the first computing device, the first server supporting a web-based application having a first user interface, the first processor causing the first display device to present on the first display device a first user interface to a user, the first user interface displaying a first item of information. The display system also includes a second server coupled to the first server via a web-based connection. The display system also includes a second computing device coupled to the second server, the second computing device supporting a desktop application including a second user interface. The web-based application contains computer-executable instructions causing the first processor to connect, after a user has opened the web-based application, to the second server and the second computing device, and in turn, to the desktop application via the web-based application. The computer-executable instructions further cause the first processor to display, within a portion of the first user interface, at least a portion of the second user interface, such that the portion of the second user interface presents to the user a second item of information that is contextually connected to the first item of information.

In another aspect, a method for configuring a display is provided. The method is implemented using a first computing device including a first processor coupled to a first display device. The method includes coupling a first server to the first computing device. The first server supports a web-based application having a first user interface. The first processor causes the first display device to present on the first display device a first user interface to a user, the first user interface displaying a first item of information. The method further includes coupling the first server to a second server via a web-based connection. The method further includes coupling a second computing device to the second server, the second computing device supporting a desktop application including a second user interface. The web-based application contains computer-executable instructions that cause the first processor to connect, after a user has opened the web-based application, to the second server and the second computing device, and in turn, to the desktop application via the web-based application. The computer-executable instructions further cause the first processor to display, within a portion of the first user interface, at least a portion of the second user interface, such that the portion of the second user interface presents to the user a second item of information that is contextually connected to the first item of information.

In another aspect, computer-readable storage media having computer-executable instructions embodied thereon are provided, wherein, when executed by at least one processor associated with a first computing device and a memory device, the computer-executable instructions cause the processor to present on a first display device a first user interface to a user, the first user interface corresponding to a web-based application. The computer-executable instructions further cause the processor to display on in the first user interface a first item of information. The computer-executable instructions further cause the processor to connect to a desktop application supported on a second computing device. The computer-executable instructions further cause the processor to display, within a portion of the first user interface, at least a portion of the second user interface, such that the portion of the second user interface presents to the user a second item of information that is contextually connected to the first item of information.

### BRIEF DESCRIPTION OF THE DRAWINGS

FIG. 1 is a simplified block diagram of an exemplary display system;

FIG. 2 is an expanded block diagram of an exemplary embodiment of a system architecture that may be used with the display system shown in FIG. 1,

FIG. 3 is a screenshot of an exemplary desktop application that may be used with the display system shown in FIG. 1;

FIG. 4 is a screenshot of an exemplary web-based application that may be used with the display system shown in FIG. 1; and

FIG. 5 is a flowchart of an exemplary method for implementing the display system of FIG. 1.

### DETAILED DESCRIPTION OF THE INVENTION

Exemplary embodiments of systems, methods, and apparatus for use in for integrating desktop applications into web-based applications for display systems in monitoring, measurement and control systems are described hereinabove. The embodiments described herein facilitate direct access by users of rich content capabilities found in desktop applications without the requirement to separately access desktop applications through remote access applications, and maintain open two separate applications, on separate screens.

A computer or server, such as those described herein, includes at least one processor or processing unit and a system memory. The computer or server typically has at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Embodiments of the invention may be described in the general context of computer-executable instructions, such as program components or modules, executed by one or more computers or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, the term “processor” refers generally to any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, the term “database” refers generally to any collection of data including hierarchical databases, relational databases, flat file databases, object-relational databases, object oriented databases, and any other structured collection of records or data that is stored in a computer system, particularly in a memory device within a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

The methods and systems described herein may be implemented using computer programming or engineering techniques including computer software, firmware, hardware or any combination or subset thereof, wherein the technical effects may be achieved by performing at least one of the following steps: a) coupling a first server to the first computing device, the first server supporting a web-based application having a first user interface, the first processor causing the first display device to present on the first display device a first user interface to a user, the first user interface displaying a first item of information; b) coupling the first server to a second server via a web-based connection; c) coupling a second computing device to the second server, the second computing device supporting a desktop application including a second user interface; d) connecting, after opening of the web-based application, to the second server and the second computing device, and in turn, to the desktop application via the web-based application; e) displaying, within a portion of the first user interface, at least a portion of the second user interface, such that the portion of the second user interface presents to the user a second item of information that is contextually connected to the first item of information; f) presenting in the first user interface at least one of a site location panel, a statistics panel, a calendar/workflow panel, and a desktop application presentation panel; g) presenting the second user interface in the desktop application presentation panel of the first user interface; h) presenting the first item of information in at least one of the site location panel, the statistics panel, and the calendar/workflow panel, and causing the first processor to present the second item of information in the desktop application presentation panel; i) implementing, in the web-based application, a first security protocol including a first set of required responses, the desktop application implementing a second security protocol including a second set of required responses that are the same as the first set of required responses; and j) presenting the desktop application in the desktop application presentation panel in one of a read-only mode and a read-write mode.

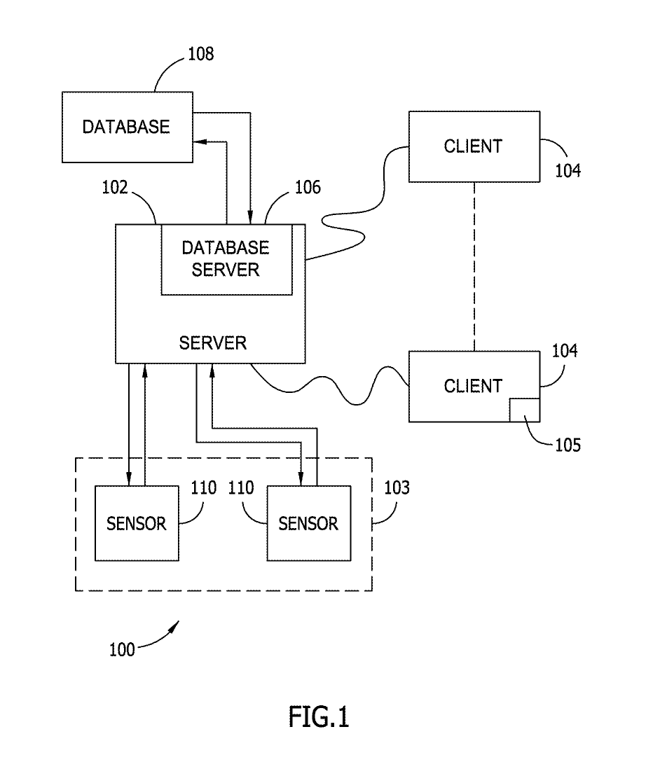

FIG. 1 is a simplified block diagram of an exemplary display system 100 for use in monitoring operations in a facility 103, such as a processing plant (a refinery, for example). In the exemplary embodiment, display system 100 includes a server system 102, and a plurality of client computers (or computing devices) 104 communicatively connected to server system 102. At least one computing device 104 includes or is coupled to a display device 105. As used herein, “server system” refers to both a single server that performs one or more functions, as well as a group of separate servers, each of which may perform one or more functions. Similarly, “server” may refer to a single server or a system comprising several servers. In the exemplary embodiment, one or more of client computers 104 is located in a control room (not shown), that is, in the exemplary embodiment, physically remote from facility 103. In alternative embodiments, the control room may be located within facility 103. In one embodiment, client computers 104 include a web browser and/or a client software application, such that server system 102 is coupled to client computers 104 over a network, such as the Internet and/or an intranet. As referred to herein, “coupled” refers to both a permanent communication connection, such as a hardwired connection or a continuously-open internet application, and an intermittent or selectively open communication connection. Client computers 104 are interconnected to the Internet through many interfaces including a network, such as a local area network (LAN), a wide area network (WAN), dial-in-connections, cable modems, wireless modems, and/or special high-speed Integrated Services Digital Network (ISDN) lines. As described above, client computers 104 may be any device capable of interconnecting to the Internet including a computer, web-based phone, personal digital assistant (PDA), or other web-based connectable equipment. A database server 106 is connected to a memory device 108 containing information on a variety of matters, such as information relating to one or more areas of interest (AOIs). In one embodiment, centralized memory device 108 is coupled within server system 102 and is accessed by potential users at one of client computers 104 by logging onto server system 102 through one of client computers 104. In an alternative embodiment, memory device 108 is situated remotely from server system 102 and may be non-centralized.

Memory device 108 may include one, or more than one, forms of memory. For example, memory device 108 can include random access memory (RAM), which can include non-volatile RAM (NVRAM), magnetic RAM (MRAM), ferroelectric RAM (FeRAM) and other forms of memory. Memory device 108 may also include read only memory (ROM), flash memory and/or Electrically Erasable Programmable Read Only Memory (EEPROM). Any other suitable magnetic, optical and/or semiconductor memory, by itself or in combination with other forms of memory, may be included in memory device 108. Memory device 108 may also be, or include, a detachable or removable memory, including, but not limited to, a suitable cartridge, disk, CD ROM, DVD or USB memory. Furthermore, memory device 108 may be organized as a database to store data regarding operational parameters and conditions within the facility and/or specific machines and machine systems within the facility.

Moreover, in the exemplary embodiment, display system 100 includes one or more remote sensors 110. Each sensor 110 gathers information about an object or area of interest. In one embodiment, sensors 110 may be sensors used for monitoring the functions of a machine or system within facility 103. For example, one or more of sensors 110 may be speed sensors used for monitoring the shaft speed of a turbine. Alternatively, one or more of sensors 110 may be temperature or pressure sensors used for monitoring conditions within a reaction vessel. In other embodiments, sensors 110 are any type of sensors that enable display system 100 to function as described herein. In the exemplary embodiment, server system 102 accesses each sensor 110 over a network, such as the Internet and/or an intranet. In some embodiments, sensors 110 are also accessible by client computers 104 over a network, such as the Internet and/or an intranet. Sensors 110 acquire data regarding the machines and/or systems to which sensors 110 are assigned, which data may be extracted by server system 102 for storage within memory device 108. Moreover, memory device 108 may include a time stamp for each datum that has been entered or modified within memory device 108. Because memory device 108 may include data extracted from multiple sensors 110, each datum stored within memory device 108 is marked by an identifier such as a key that corresponds to an AOI that relates to the relevant datum. In the exemplary embodiment, server system 102 can be used to support a web-based application that integrates desktop applications, to enable facilitated monitoring, measurement and control of one or more machines or systems within a facility.

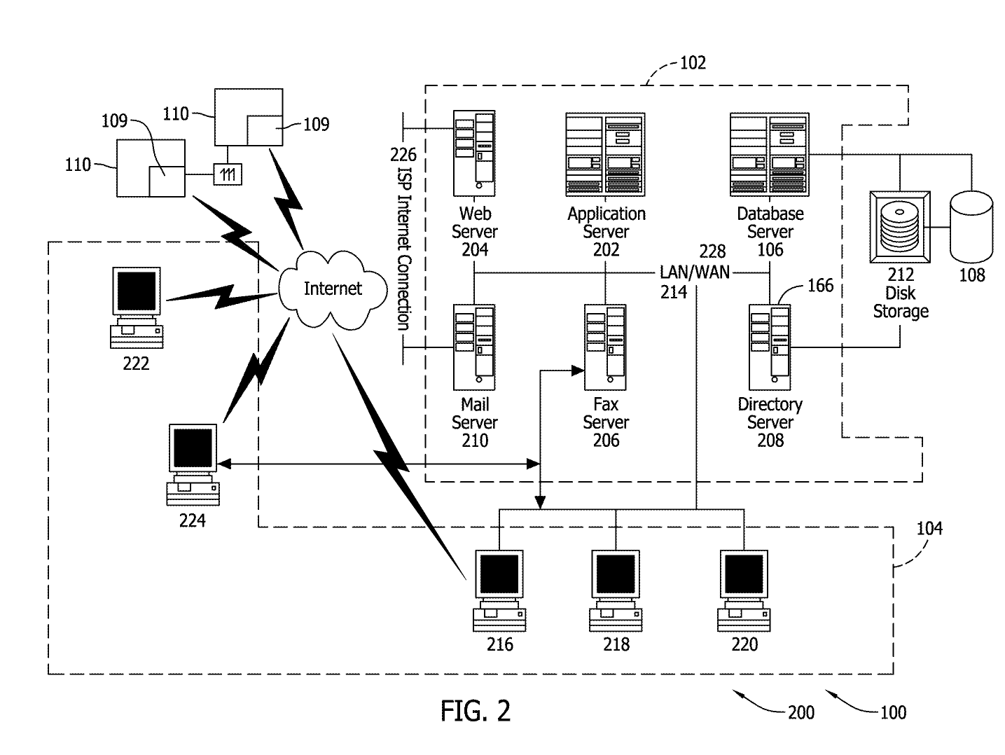

FIG. 2 is an expanded block diagram of an exemplary embodiment of a system architecture 200 of display system 100 (shown in FIG. 1). Components in system architecture 200, identical to components of display system 100, are identified in FIG. 2 using the same reference numerals as used in FIG. 1. System architecture 200 includes server system 102, and client computers 104 coupled to server system 102. Server system 102 further includes database server 106, an application server 202, a web server 204, a fax server 206, a directory server 208, and a mail server 210. A disk storage unit 212 is coupled to database server 106 and directory server 208. Examples of disk storage unit 212 include, but are not limited to including, a Network Attached Storage (NAS) device and a Storage Area Network (SAN) device. Database server 106 is also coupled to memory device 108. Servers 106, 202, 204, 206, 208, and 210 are coupled in a local area network (LAN) 214. Client computers 104 may include a system administrator workstation 216, a user workstation 218, and a supervisor workstation 220 coupled to LAN 214. Alternatively, client computers 104 may include workstations 216, 218, 220, 222, and 224 that are coupled to LAN 214 using an Internet hyperlink (or “link”) or are connected through an intranet.

Each client computer 104, including workstations 216, 218, 220, 222, and 224, may be a personal computer having a web browser and/or a client application. Server system 102 is configured to be communicatively coupled to client computers 104 to enable server system 102 to be accessed using an Internet connection 226 provided by an Internet Service Provider (ISP). The communication in the exemplary embodiment is illustrated as being performed using the Internet, however, any suitable wide area network (WAN) type communication can be utilized in alternative embodiments, that is, the systems and processes are not limited to being practiced using the Internet. In addition, local area network 214 may be used in place of WAN 228. Further, fax server 206 may communicate with remotely located client computers 104 using a telephone link.

Moreover, in the exemplary embodiment, server system 102 is communicatively coupled to one or more remote sensors 110 that acquire data, such as machine operations or status information. Server system 102 is configured to be communicatively coupled to each sensor 110 to enable server system 102 to access each sensor 110 using Internet connection 226. Specifically, in the exemplary embodiment, a computing device 109 is coupled to each sensor 110. Computing devices 109 are not connected to server system 102, except as described herein. Specifically, computing devices 109 are coupled to and served by a server system 111. In the exemplary embodiment, server system 111 may be substantially similar to, or is provided with similar functionalities as server system 102. However, server system 111 is physically remote from server system 102. That is, server system 111 and server system 102, regardless of how much physical distance (if any) separates them, are connectable through internet connection 226, rather than through a permanent hard-wired connection (or similar connection). The communication in the exemplary embodiment is illustrated as being performed using the Internet, however, any suitable wide area network (WAN) type communication can be utilized in alternative embodiments, that is, the systems and processes are not limited to being practiced using the Internet, unless otherwise specified. In addition, local area network 214 may be used in place of WAN 228. Server system 102 is further configured to extract data from each sensor 110 that is specified as a data origin. Server system 102 extracts the data and stores the data within memory device 108.

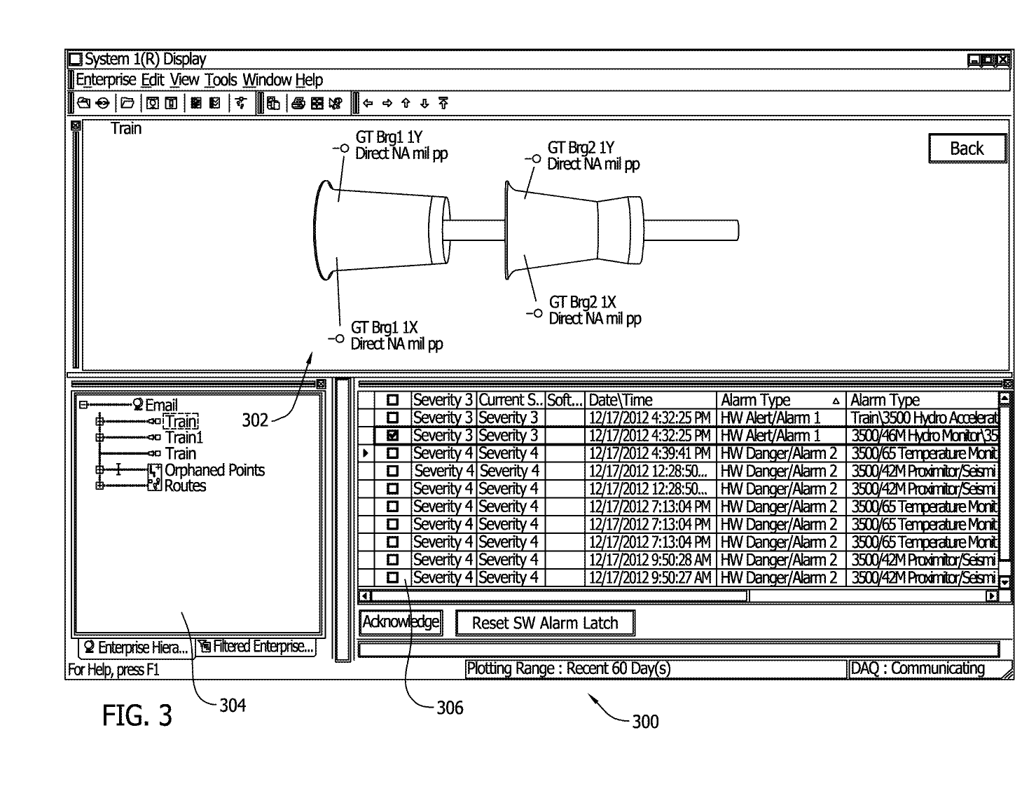

FIG. 3 is a screenshot of an exemplary desktop application user interface 300 (also referred to as a “second user interface”) that may be implemented in exemplary display system 100. In the exemplary embodiment, the desktop application supporting desktop application user interface 300 is resident on one or more of computing devices 109. User interface 300 includes a schematic representation 302 of a machine (in the exemplary embodiment, a turbine). In addition, user interface 300 includes a menu panel 304, enabling a user to select amongst a plurality of machines or systems to monitor. User interface 300 further includes an information panel 306, from which a user can obtain detailed information regarding the machine or system that is being displayed in schematic representation 302. In the exemplary embodiment, the desktop application that supports user interface 300 includes include analytical tools and other rich functionalities not typically present in web-based applications, that enable a user to access, and perform functions relating to, data being acquired, for example, through sensors 110. Although a particular configuration of desktop application user interface 300 is illustrated in FIG. 3, and described in the exemplary embodiment, in alternative embodiments, other configurations of desktop application user interface 300, having different functionalities, may be provided.

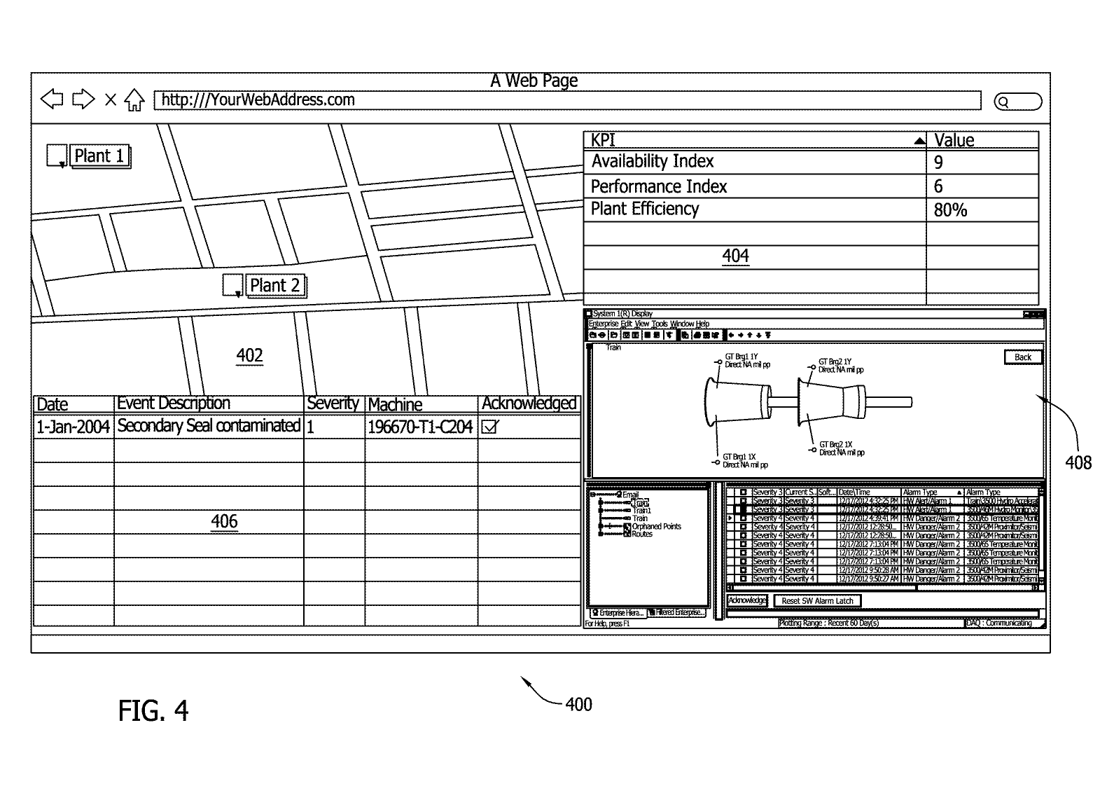

FIG. 4 is a screenshot of an exemplary web-based application user interface 400 (also referred to as “first user interface”) that may be used in exemplary display system 100. In the exemplary embodiment, the web-based application that supports web-based application user interface 400 is supported on one or more of client computers 104, specifically, one or more of workstations 216, 218, 220, 222 and 224, such as workstation 216. In the exemplary embodiment, workstation 216 and computing devices 109 are supported by separate server systems 102 and 111, respectively, and are connectable to each other via a web-based connection, such as internet connection 226. In the exemplary embodiment, workstation 216 accesses a web-based application and its corresponding web-based application user interface 400 through an internet connection. However, as used herein, “web-based application” also refers to an application that may be accessed through any other suitable communication system, such as an intranet, local area network (“LAN”), or other private network. In alternative embodiments, workstation 216 and computing device(s) 109 are physically proximate each other, and/or can communicate with one another via hardwire connection (such as Ethernet), optical link, Wi-Fi or Bluetooth®-type connections, or any other communication mechanism that enables display system 100 to function as described herein.

Web-based application user interface 400 includes a site location panel 402 that illustrates a location on a map of a facility (labeled “Plant 2” in site location panel 402 of FIG. 4), information regarding the general operations of which are presented in web-based application user interface 400. Web-based application user interface 400 additionally includes a statistics panel 404 that presents one or more predefined categories of operational statistics pertaining to the facility illustrated in site location panel 402. A calendar/workflow panel 406 lists one or more events or job actions associated with the facility schematically illustrated in site location panel 402, which events or job actions require acknowledgement and/or intervention on the part of the user accessing web-based application user interface 400. In addition, in the exemplary embodiment, web-based application user interface 400 includes a desktop application presentation panel 408, which presents desktop application user interface 300 illustrated in FIG. 3. In the exemplary embodiment, desktop application user interface 300 is associated with a desktop application that includes functionalities and features that are associated with, and relevant to, monitoring, measurement, and/or control functions pertaining to facility 103 illustrated in site location panel 402. Although a particular configuration of web-based application user interface 400 is illustrated in FIG. 4, and described in the exemplary embodiment, in alternative embodiments, other configurations of web-based application user interface 400, having different functionalities, may be provided.

Site location panel 402, statistics panel 404, calendar/workflow panel 406 and desktop application presentation panel 408 shown in FIG. 4 are illustrated as an example of a configuration of web-based application user interface 400. In alternative embodiments, panels providing other forms of information are provided. In addition, in an embodiment, desktop application presentation panel 408 is not immediately present in web-based application user interface 400. That is, system 100 may initially present, in web-based application user interface 400, a first summary layer of information, and a user will need to access further layer(s) of interface 400 in order to arrive at desktop application presentation panel 408. Specifically, in an embodiment, web-based application user interface 400 provides one or more panels presenting summary information to the user, together with a mechanism (such as a “button” or drop-down menu) that enables a user to access more detailed information and/or perform detailed analysis functions. For example, web-based application user interface 400 may be provided with one or more button(s) or menu(s) that enable a user to use filtering criteria (such as selecting a particular machine, or sensor or area on a particular machine), and then enter a selection such as “analysis”, which causes system 100 to then present desktop application presentation panel 408 (which will display relevant in-context information relating to the machine, sensor, or area previously selected by the user).

In the exemplary embodiment, to enable display system 100 to present a desktop application within the web-based application, an application designer inserts into the web-based application a hyperlink (or “link”) (not shown) within desktop application presentation panel 408 as presented to a user. The link, when “clicked” on by a user, causes display system 100 to connect to, and open the desired desktop application, if it is not already running. The link includes the IP address for the desktop application resident in computing device(s) 109, and such other information as required to enable display system 100 to function as described. A remote desktop web control, for example, the Remote Desktop Services component in Windows Server® 2008 R2, operating within display system 100, and specifically within the web-based application, enables a user at workstation 216 to connect, through the web-based application, to computing devices 109, to access the desktop application.

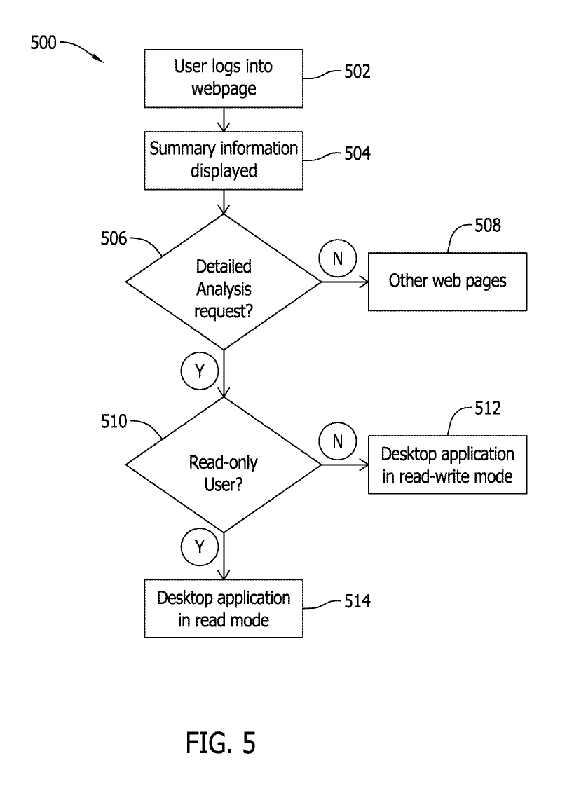

FIG. 5 is a flowchart of an exemplary method 500 for implementing display system 100. In the exemplary embodiment, a user accesses (or “logs into”) 502 a web-based application (or “web page”) at workstation 216, display system 100 presents 504 the user with web-based application user interface 400. When display system 100 initially presents 504 web-based application user interface 400 to a user, desktop application presentation panel 408 is substantially blank, except for one or more virtual action “buttons” (not shown) described herein. For example, if the user determines that no detailed analysis of information presented in web-based application user interface 400 is required, the user causes display system 100 to access 508 other pages of the web-based application. Alternatively, if the user determines that detailed analysis of information presented in web-based application user interface 400 is required, the user causes display system 100 to access 510 the desktop application. In the exemplary embodiment, display system 100 causes web-based application user interface 400 to present to a user two or more virtual buttons displayed in desktop application presentation panel 408 that may be labeled, for example, “READ-ONLY” and “READ-WRITE.” If the user “clicks” on the “READ-WRITE” button, display system 100 presents 512 desktop application user interface 300 in desktop application presentation panel 408, with desktop application user interface 300 containing information specifically associated with the facility illustrated in site location panel 402 and with the specific events or action items being displayed in web-based application user interface 400. Display system 100 enables desktop application user interface 300 enables to respond to user commands to enable the user to access such rich content features that the specific desktop application is provided with. Alternatively, if the user only requires a “READ-ONLY” version of the desktop application, the user “clicks” on the “READ-ONLY” button, and display system 100 causes web-based application user interface 400 to present 514 a “READ-ONLY” version of the desktop application in desktop application presentation panel 408. In alternative embodiments, when a user initially accesses web-based application user interface 400, desktop application presentation panel 408 may include a single virtual action “button” (not shown), for example, labeled “launch.” Upon clicking on a “launch” button, a subsequent screen may appear within desktop application presentation panel 408, with a dialog box having text such as “Launch Read Only?” with “YES” and “NO” virtual buttons appearing within the box.

Whether the “READ-ONLY” or the “READ-WRITE” mode is selected, display system 100 presents desktop application user interface 300 in desktop application presentation panel 408 in context. As used herein, “in context” means that as soon as the desktop application is invoked, display system 100 causes information displayed in desktop application presentation panel 408 to be contextually associated with at least one of the site, events or job actions, and/or statistics being displayed elsewhere in web-based application user interface 400, at the time that the desktop application is invoked. Accordingly, a user, upon initially invoking the desktop application, does not need to enter information, or “click” on any “buttons” in order to coordinate the desktop application with the web-based application. In the exemplary embodiment, display system 100 causes the desktop application, at launch, to be configured to fit within a web page window (such as desktop application presentation panel 408, as shown in FIG. 4), so that the desktop application has an appearance similar to customary web pages or web controls. In the exemplary embodiment, an application designer inserts into the desktop application appropriate code that causes the desktop application to acquire, from the web-based application, one or more predefined items of information corresponding to information entered by a user accessing the web-based application directly.

In the exemplary embodiment, display system 100 is configured so that security protocols applicable to specific users of an underlying desktop application are applied when an underlying desktop application is invoked through a web-based application. Specifically, an application designer configuring the desktop application for integration into the web-based application inserts into the desktop application appropriate code that will cause the web-based application to apply the same security protocol (“first security protocol”) as would be applicable, when a user directly accesses the desktop application (“second security protocol”). Accordingly, when a user initially accesses the web-based application, display system 100 causes the web-based application to prompt the user to input the same (or compatible) security information (or “required responses”) to complete launching of the web-based application, as the desktop application would require, if the user were attempting to access the desktop application directly. Accordingly, when the user enters the requested security information, display system 100 causes the security information (“required responses”) entered by the user to be transmitted, via the remote access connection, to the desktop application. Accordingly, to the extent that different users of the desktop application have different levels of security access, the same different levels of security access will be applicable to those users when accessing the web-based application.

In the exemplary embodiment, implementation of a remotely accessed desktop application may be a feature installed during initial set-up of display system 100. Alternatively, implementation of a remotely accessed desktop application may be a feature that is retrofitted into an existing web-based application.

Exemplary embodiments of systems, methods, and apparatus for displaying a desktop application within a web-based application are described above in detail. The systems, methods, and apparatus are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

Although the present invention is described in connection with an exemplary processing plant environment, embodiments of the invention are operational with numerous other industrial and non-industrial environments and applications. The processing plant environment is not intended to suggest any limitation as to the scope of use or functionality of any aspect of the invention. Moreover, the processing plant environment should not be interpreted as having any dependency or requirement relating to any one or combination of components illustrated in the exemplary operating environment.

In contrast to known display systems for use in web-based applications for monitoring, measurement and controls systems, the display systems and methods described herein enable web-based applications to make use of existing desktop applications that incorporate richer user interface features than are provided in existing web-based applications. In addition, the display systems and methods described herein enable existing desktop applications to be used, without requiring that the web-based applications be rewritten to incorporate desirable richer user interface features found in desktop applications. The display systems and methods described herein also facilitate making updates to web-based applications, in that updates to the web-based applications themselves are not required. Rather, updates made to desktop applications implemented through the web-based applications are directly accessed, when a user logs onto the web-based application, and activates the desktop application through desktop application presentation panel 408.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A display system for use in integrating a desktop application user interface into a web-based application, said display system comprising:
a first computing device including a first processor coupled to a first display device;
a first server coupled to said first computing device, said first server supporting a web-based application having a first user interface, said first processor causing said first display device to present on said first display device a first user interface to a user, said first user interface displaying a first item of information;
a second server coupled to said first server via a web-based connection; and
a second computing device coupled to said second server, said second computing device supporting a desktop application including a second user interface;
said web-based application containing computer-executable instructions, said computer-executable instructions causing said first processor to connect, after a user has opened said web-based application, to said second server and said second computing device, and in turn, to said desktop application via said web-based application, and
the computer-executable instructions further causing said first processor to display, within a portion of said first user interface, at least a portion of said second user interface, such that said portion of said second user interface presents to said user a second item of information that is contextually connected to said first item of information.

2. A display system in accordance with claim 1, comprising a sensor apparatus coupled to at least one of said first computing device and said second computing device.

3. A display system in accordance with claim 1, wherein said computer-executable instructions cause said first processor to present in said first user interface at least one of a site location panel, a statistics panel, a calendar/workflow panel, and a desktop application presentation panel.

4. A display system in accordance with claim 3, wherein said computer-executable instructions cause said first processor to present said second user interface in said desktop application presentation panel of said first user interface.

5. A display system in accordance with claim 4, wherein said computer-executable instructions cause said first processor to present said first item of information in at least one of said site location panel, said statistics panel, and said calendar/workflow panel, and cause said first processor to present said second item of information in said desktop application presentation panel.

6. A display system in accordance with claim 1, wherein said computer-executable instructions cause said first processor to implement, in said web-based application, a first security protocol including a first set of required responses, and said desktop application implements a second security protocol including a second set of required responses that are the same as said first set of required responses.

7. A display system in accordance with claim 1, wherein said computer-executable instructions cause said first processor to present said desktop application in said desktop application presentation panel in one of a read-only mode and a read-write mode.

8. A method for configuring a display, said method implemented using a first computing device including a first processor coupled to a first display device, said method comprising:
coupling a first server to the first computing device, the first server supporting a web-based application having a first user interface, the first processor causing the first display device to present on the first display device a first user interface to a user, the first user interface displaying a first item of information;
coupling the first server to a second server via a web-based connection; and
coupling a second computing device to the second server, the second computing device supporting a desktop application including a second user interface;
the web-based application containing computer-executable instructions, the computer-executable instructions causing the first processor to connect, after a user has opened the web-based application, to the second server and the second computing device, and in turn, to the desktop application via the web-based application, and
the computer-executable instructions further causing the first processor to display, within a portion of the first user interface, at least a portion of the second user interface, such that the portion of the second user interface presents to the user a second item of information that is contextually connected to the first item of information.

9. A method in accordance with claim 8, said method comprising coupling a sensor apparatus to at least one of the first computing device and the second computing device.

10. A method in accordance with claim 8, said method further comprising presenting in the first user interface at least one of a site location panel, a statistics panel, a calendar/workflow panel, and a desktop application presentation panel.

11. A method in accordance with claim 10, said method further comprising presenting the second user interface in the desktop application presentation panel of the first user interface.

12. A method in accordance with claim 11, said method further comprising presenting the first item of information in at least one of the site location panel, the statistics panel, and the calendar/workflow panel, and cause the first processor to present the second item of information in the desktop application presentation panel.

13. A method in accordance with claim 8, said method further comprising implementing, in the web-based application, a first security protocol including a first set of required responses, the desktop application implementing a second security protocol including a second set of required responses that are the same as the first set of required responses.

14. A method in accordance with claim 8, said method further comprising presenting the desktop application in the desktop application presentation panel in one of a read-only mode and a read-write mode.

15. Computer-readable storage media having computer-executable instructions embodied thereon, wherein, when executed by at least one processor associated with a first computing device and a memory device, said computer-executable instructions cause said processor to:
present on a first display device a first user interface to a user, said first user interface corresponding to a web-based application;
display on said first user interface a first item of information;
connect to a desktop application supported on a second computing device; and
display, within a portion of said first user interface, at least a portion of said second user interface, such that said portion of said second user interface presents to said user a second item of information that is contextually connected to said first item of information.

16. The computer-readable storage media in accordance with claim 15, wherein said computer-executable instructions cause said first processor to present in said first user interface at least one of a site location panel, a statistics panel, a calendar/workflow panel, and a desktop application presentation panel.

17. The computer-readable storage media in accordance with claim 16, wherein said computer-executable instructions cause said first processor to present said second user interface in said desktop application presentation panel of said first user interface.

18. The computer-readable storage media in accordance with claim 17, wherein said computer-executable instructions cause said first processor to present said first item of information in at least one of said site location panel, said statistics panel, and said calendar/workflow panel, and cause said first processor to present said second item of information in said desktop application presentation panel.

19. The computer-readable storage media in accordance with claim 15, wherein said computer-executable instructions cause said first processor to implement, in said web-based application, a first security protocol including a first set of required responses, said desktop application implementing a second security protocol including a second set of required responses that are the same as said first set of required responses.

20. The computer-readable storage media in accordance with claim 15, wherein said computer-executable instructions cause said processor to couple a first server, on which said first computing device is supported, to a second server, on which said second computing device is supported.
